(19) United States
(12) Patent Application Publication
(10) Pub. No.: US 2009/0161081 A1
(43) Pub. Date: Jun. 25, 2009

(54) Optical Engine Structure, Rear Projection Apparatus, and Front Projection Apparatus

(75) Inventor: June-Jei Huang, Taoyuan Hsien (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: Delta Electronics, Inc., Taoyuan Hsien (TW)

(21) Appl. No.: 12/142,911

(22) Filed: Jun. 20, 2008

(30) Foreign Application Priority Data
Dec. 20, 2007 (TW) 096148933

(51) Int. Cl. G03B 21/14

(52) U.S. Cl. 353/119

(57) ABSTRACT

An optical engine structure is provided. The optical engine structure comprises a base, an auxiliary supporting device, and an image projection device. The base defines a first supporting surface and a second supporting surface forming a specialized included angle therebetween. The auxiliary supporting device extends outwards from a side of the second supporting surface, and thereby the optical engine structure firmly lies on a reference plane with the first supporting surface or the second supporting surface, corporately supported by the auxiliary supporting device. By utilizing these two supporting surfaces, the image projection device can be easily set in a front projection apparatus or a rear projection apparatus.

This application claims priority to Taiwan Patent Application No. 096148933 filed on Dec. 20, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to an optical engine structure, and more particularly, relates to an optical engine structure capable of being used in both a front projection apparatus and a rear projection apparatus for projecting images.

2. Descriptions of the Related Art

With the rapid development of modern society and the booming hi-tech industries, consumers now have a wide variety of display apparatuses available for acquiring various information. Among these display apparatuses, projection apparatuses are able to zoom in or out an image displayed as needed, and thus has been widely adopted in offices, houses, meeting rooms or other similar places. Projection apparatuses have two major applications: one is the front projection apparatus, i.e. the common projector, while the other is a rear projection apparatus for use in a rear projection television.

Unlike other usage patterns of other conventional display apparatuses, a conventional front projection apparatus must be located on the same side as the user with respect to the display plane due to the projection properties thereof. To cater for the user's usage habits and to allow the display of larger frames, a variety of rear projection apparatuses have emerged accordingly.

However, compared to the rear projection apparatuses, the front projection apparatuses still have unique advantages that render them irreplaceable, for example, a front projection apparatus can zoom the image in or out as needed, project an image onto any plane, and so on. Because the both kinds of projection apparatuses cannot be replaced by each other, it is highly desirable to provide an image projection apparatus incorporating the capabilities of both the front projection apparatus and rear projection apparatus.

As shown in FIG. 1, a conventional rear projection apparatus 1 utilizes an image projection device 10 originally used in a front projection apparatus. The image projection device 10 is detachably disposed in the rear projection apparatus 1 for projecting an image onto a projection screen 11 by optical reflection. Like the front projection apparatus, the image projection device 10 is disposed in the rear projection apparatus 1 horizontally or with a small elevation angle. As shown in a cross-sectional view of FIG. 2, the image projection device 10 at first projects an image onto a first reflecting surface 12, which then reflects the image to a second reflecting surface 13. The image is further reflected by the second reflecting surface 13 to a third reflecting surface 14, and is finally projected by the third reflecting surface 14 onto the projection screen 11. Although the image projection device 10 may be detached and used as a front projection apparatus, it can only be disposed horizontally or with a small elevation angle. Accordingly, when the image projection device 10 is used in the projection apparatus 1, after three reflections can the image be displayed on the projection screen 11. As a result, the complex structure and optical loss incurred by the multiple reflections present serious problems when the image projection device 10 is used in a rear projection apparatus.

In view of this, it is highly desired in the field to provide an image projection apparatus for use in both a front projection apparatus and a rear projection apparatus and capable of minimizing the complexity of the rear projection apparatus and optical loss when used in the rear projection apparatus.

### SUMMARY OF THE INVENTION

One objective of this invention is to provide an optical engine structure, which comprises a base, an auxiliary supporting device and an image projection device. The base has a first supporting surface and a second supporting surface. The two supporting surfaces form an included angle therebetween, so that the optical engine structure is adapted to lie on a reference plane with one of the first supporting surface and the second supporting surface respectively. The image projection device has a main optical axis substantially parallel to the second supporting surface. With such an arrangement, the image projection device is able to project an image at an appropriate angle.

Another objective of this invention is to provide a rear projection apparatus comprising the optical engine structure described above. The optical engine structure lies on the reference plane with the first supporting surface. In this way, an image can be projected by the image projection device onto a projection screen.

Yet a further objective of this invention is to provide a front projection apparatus comprising the optical engine structure described above. The optical engine structure lies on the reference plane with the second supporting surface. In this way, an image can be projected by the image projection device onto a display plane.

Because the two supporting surfaces have particular projection angles needed to dispose the optical engine structure in the front projection apparatus and the rear projection apparatus, the image projection device of the optical engine structure can firmly lie on the reference plane. As a result, the optical engine structure has been used for both the front projection apparatus and the rear projection apparatus have been accomplished.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a perspective view of a conventional rear projection apparatus;

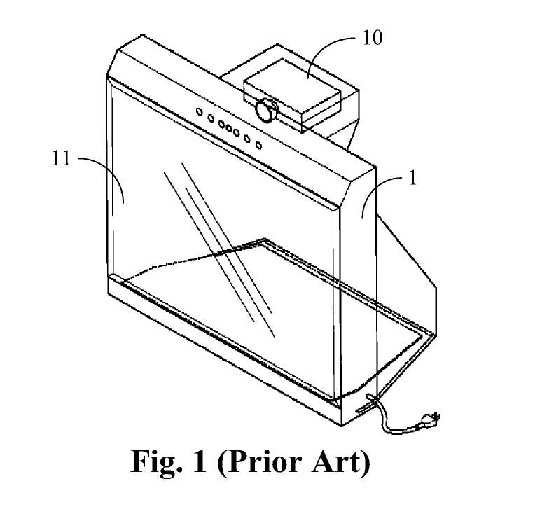

FIG. 2 is a cross-sectional side view of the conventional rear projection apparatus;

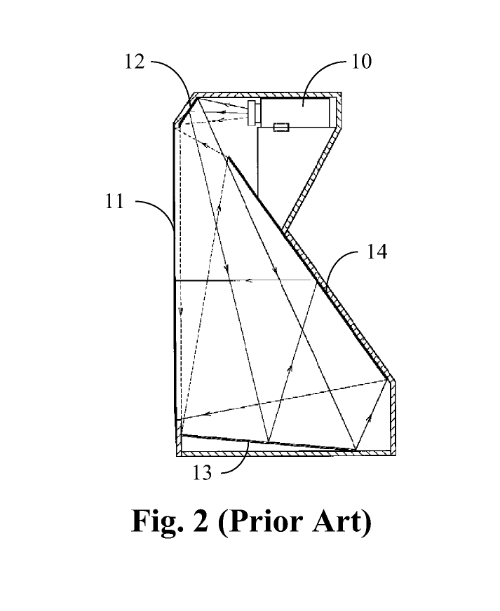

FIG. 3 is a cross-sectional side view of a rear projection apparatus according to a first embodiment of this invention;

FIG. 4 is a schematic view of an optical engine structure according to the first embodiment of this invention;

FIG. 5 is a schematic view of an auxiliary supporting device according to the first embodiment of this invention; and

FIG. 6 is a schematic view of a front projection apparatus according to a second embodiment of this invention.

### DESCRIPTION OF THE PREFERRED EMBODIMENT

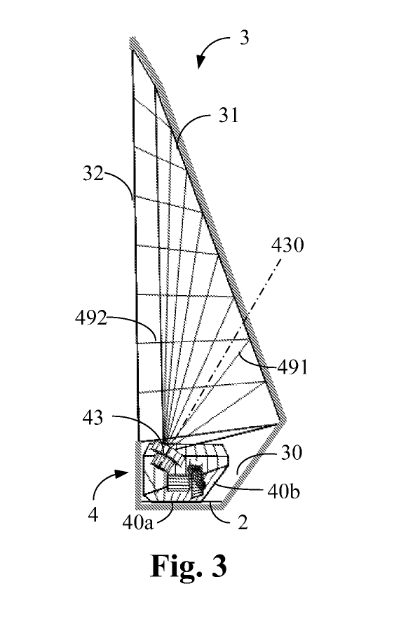

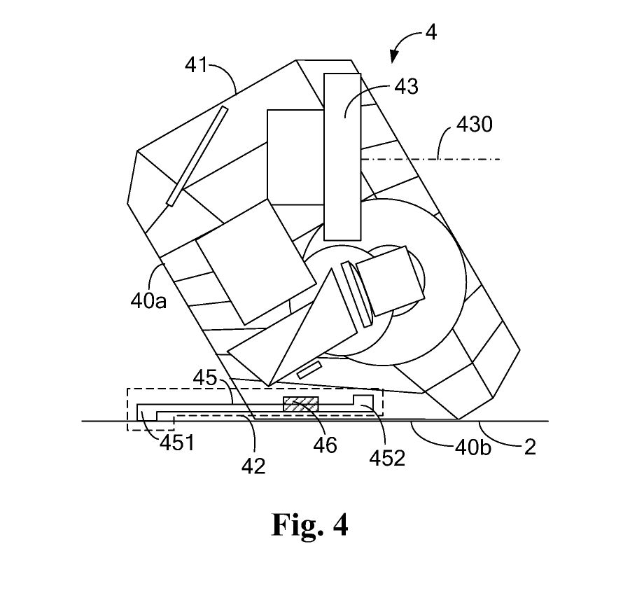

The first embodiment of this invention is a rear projection apparatus 3, a schematic view of which is depicted in FIG. 3. In this embodiment, the rear projection apparatus 3 is a rear projection television. The rear projection television 3 comprises an optical engine structure 4, a receiving space 30, a reflecting surface 31 and a projection screen 32. FIG. 4 depicts a schematic view of the optical engine structure 4, which comprises a base 41, a stabilizing device and an image projection device 43. The image projection device 43 has a main optical axis 430 substantially parallel to a second supporting surface 40b.

As shown in FIG. 4, the base 41 has a first supporting surface 40a and the second supporting surface 40b. The two supporting surfaces 40a, 40b form an included angle therebetween, so that the optical engine structure 4 is adapted to lie on a reference plane 2 with either the first supporting surface 40a or the second supporting surface 40b. In this embodiment, the first supporting surface 40a and the second supporting surface 40b adjoin each other with an included angle of 120° formed therebetween. However, in other examples, rather than adjoining each other, the first supporting surface 40a and the second supporting surface 40b may also have another flat or curved surface interposed therebetween. Furthermore, when adjoined with each other, the two supporting surfaces may also form a different included angle therebetween, and thus, no limitation is imposed herein.

The stabilizing device is configured to allow the optical engine structure 4 to firmly lie on the reference plane 2. The stabilizing device can be disposed on either the first supporting surface 40a or the second supporting surface 40b. In this embodiment, the stabilizing device is an auxiliary supporting device 42. The auxiliary supporting device 42 extends outwards from a side of the second supporting surface 40b and is disposed inside the base 41, so that the optical engine structure 4 is allowed to lie on the reference plane 2 firmly. In other examples, the auxiliary supporting device 42 may also be disposed outside the base 41. The stabilizing device may also be an auxiliary weight device (not shown), which may be provided on the second supporting surface 40b to add to the weight on the side of the second supporting surface 40b.

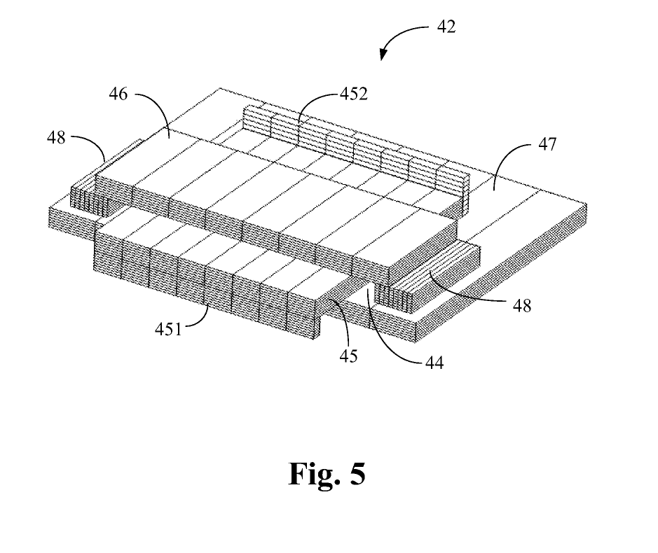

As shown in FIG. 5, the auxiliary supporting device 42 of the optical engine structure 4 comprises a slide groove 44 and an extending board 45. The slide groove 44, which is formed substantially parallel to the second supporting surface 40b for the extending board 45 to be inserted therethrough, is a space defined by a blocking board 46, a bottom board 47 opposite to the blocking board 46, and two side boards 48 opposite to each other. The extending board 45 comprises a supporting leg 451 and a block 452 extending downwards from a front end of the extending board 45 and upwards from a rear end of the extending board 45 respectively. The extending board 45 is adapted to slide within the slide groove 44 along a plane direction parallel to the second supporting surface 40b. The extended board 45 is adapted to move between a retracted position where the supporting leg 451 abuts against the bottom board 47 and an extended position where the block 452 abuts against the blocking board 46. When the extending board 45 is in the extended position, the supporting leg 451 is adapted to firmly support the optical engine structure 4 on the reference plane 2. The block 452 is adapted to abut against a rear end of the blocking board 46 to prevent the extending board 45 from sliding out. The optical engine structure 4 has a center of gravity. When the extending board 45 is in the extended position, a normal of the second supporting surface 40b crossing the center of gravity, i.e. a plumb line passing the center of gravity, intersects the extending board 45.

When used in the aforementioned rear projection apparatus 3, the optical engine structure 4 lies on the reference plane 2 with the first supporting surface 40a as shown in FIG. 3, i.e., on a bottom surface of the receiving space 30 parallel to an external resting surface. Therefore, the auxiliary supporting device 42 for support of the second supporting surface 40b is unnecessary, and in this case, the extending board 45 is in the retracted position. The main optical axis 430 of the image projection device 43 of the optical engine structure 4 is parallel to the second supporting surface 40b and intersects the reflecting surface 31. In this position, the main optical axis 430 and the reference plane 2 form an included angle of 60° therebetween. When an image is projected by the image projection device 43 of the optical engine structure 4, the projection light 491 impinges on the reflecting surface 31 and is reflected into a reflecting light 492, which then impinges on the projection screen 32 to display the image thereon. Because the light forming the image is reflected only once, the optical loss is extremely low.

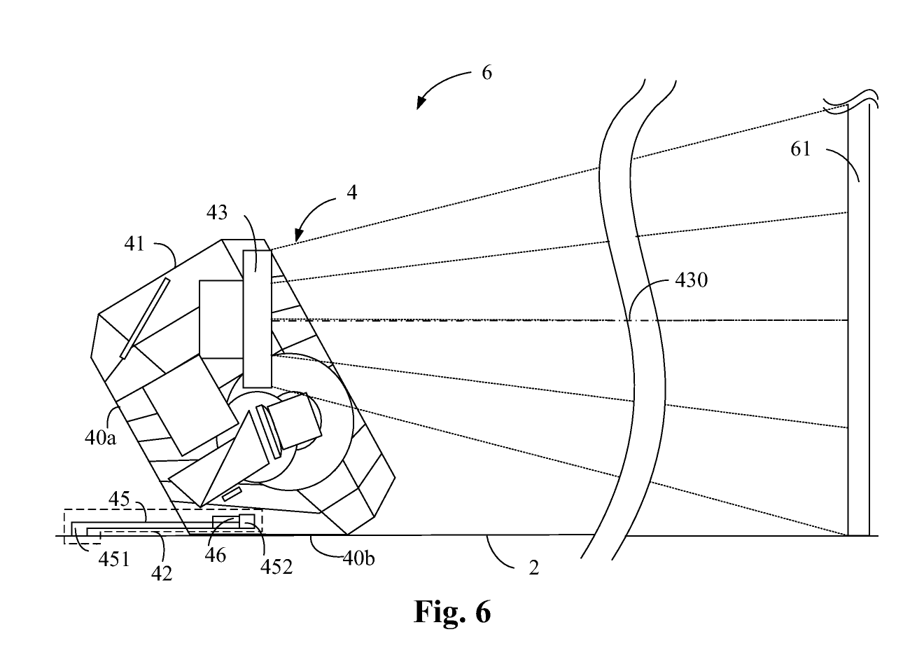

The second embodiment of this invention is a front projection apparatus 6, a schematic view of which is depicted in FIG. 6. In this embodiment, the front projection apparatus 6 is a projector. The optical engine structure 4 of this embodiment is identical to that of the first embodiment, and thus a detailed description thereof will be omitted herein.

The second embodiment differs from the first embodiment primarily in that, when using the optical engine structure 4 of the second embodiment, it is the second supporting surface 40b that lies on the reference plane 2, i.e., the external plane where the optical engine structure 4 lies. More specifically, when the optical engine structure 4 is used in a front projection apparatus 6 as shown in FIG. 6, it is the second supporting surface 40b that lies on the reference plane 2, and an image is projected by the image projection device 43 along the main optical axis 430 onto a display plane 61.

The optical engine structure 4 of this embodiment arranges the second supporting surface 40b firmly on the reference plane 2 by a stabilizing device. As in the first embodiment, the stabilizing device is an auxiliary supporting device 42, although an auxiliary weight element may also be used in other examples. In this embodiment, to have the optical engine structure 4 lie firmly on the reference plane 2 with the second supporting surface 40b, the extending board 45 of the auxiliary supporting device 42 is extended to the extended position, so that the supporting leg 451 abuts against and lies firmly on the reference plane 2 and the normal of the second supporting surface 40b crossing the center of gravity of the optical engine structure 4 intersects the extending board 45.

The above embodiments detail how this invention simply applies a single optical engine structure 4 in both a rear projection apparatus 3 and a front projection apparatus 6. When applied in a rear projection apparatus 3, the optical engine structure 4 is simply disposed into the receiving space 30 with the first supporting surface 40a thereof lying on the reference plane 2, and then the image projected by the image projection device 43 can be displayed onto the projection screen 32. When the optical engine structure 4 is applied in a front projection apparatus 6, what needs to be done is only to pull the extending board 45 to the extended position and have the second supporting surface 40b lie on the reference plane 2. Moreover, the angle included between the main optical axis 430 and the first supporting surface 40a is adapted to be adjusted as required in the design process. In other words, the requirements and configurations for the optical path are more flexible while the optical engine structure 4 is applied in the rear projection apparatus 3. For example, in the design shown in FIG. 3, the image projected from the image projection device 43 is reflected only once before being displayed on the projection screen 32, thus preventing optical loss incurred from multiple reflections.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An optical engine structure, comprising:
a base having a first supporting surface and a second supporting surface, both of which form an included angle therebetween, wherein one of the first supporting surface and the second supporting surface of the optical engine structure is adapted to lie on a reference plane; and
an image projection device having a main optical axis, substantially parallel to the second supporting surface.

2. The optical engine structure as claimed in claim 1, further comprising a stabilizing device to allow the optical engine structure to firmly lie on the reference plane.

3. The optical engine structure as claimed in claim 2, wherein the stabilizing device is an auxiliary supporting device, extending outward from a side of one of the first supporting surface and the second supporting surface.

4. The optical engine structure as claimed in claim 2, wherein the stabilizing device is an auxiliary weight element, disposed on one of the first supporting surface and the second supporting surface.

5. The optical engine structure as claimed in claim 3, wherein the auxiliary supporting device extends outward from the second supporting surface and comprises:
a slide groove substantially parallel to the second supporting surface; and
an extending board adapted to move between a retracted position and an extended position along a plane direction parallel to the second supporting surface within the slide groove.

6. The optical engine structure as claimed in claim 5, further comprising a blocking board, a bottom board opposite to the blocking board and two side boards opposite to each other, all of which corporately forming the slide groove.

7. The optical engine structure as claimed in claim 6, wherein the extending board comprises a supporting leg and a block, respectively extending downward from a front end of the extending board and extending upward from a rear end of the extending board, while the extending board is in the extended position, the supporting leg is adapted to support the optical engine structure to lie on the reference plane firmly and the block is adapted to block a rear end of the blocking board to prevent the extending board from sliding out.

8. The optical engine structure as claimed in claim 5, wherein the optical engine structure has a center of gravity, while the extending board is in the extended position, a normal of the second supporting surface crossing the center of gravity is adapted to intersect the extending board.

9. The optical engine structure as claimed in claim 3, wherein the auxiliary supporting device is disposed inside the base.

10. The optical engine structure as claimed in claim 3, wherein the auxiliary supporting device is disposed outside the base.

11. The optical engine structure as claimed in claim 1, wherein the included angle is substantially 120°.

12. A rear projection apparatus, comprising the optical engine structure as claimed in claim 1, wherein the optical engine structure lies on the reference plane with the first supporting surface.

13. The rear projection apparatus as claimed in claim 12, further comprising a projection screen to display an image projected by the image projection device.

14. The rear projection apparatus as claimed in claim 12, wherein the rear projection apparatus is a rear projection television.

15. A front projection apparatus, comprising the optical engine structure as claimed in claim 1, wherein the optical engine structure lies on the reference plane with the second supporting surface.

16. The front projection apparatus as claimed in claim 15, further comprising a stabilizing device to allow the optical engine structure to lie on the reference plane firmly.

17. The front projection apparatus as claimed in claim 16, wherein the stabilizing device is an auxiliary supporting device, extending outward from the second supporting surface, comprising:
a slide groove substantially parallel to the second supporting surface; and
an extending board adapted to move between a retracted position and an extended position along a plane direction parallel to the second supporting surface within the slide groove.

18. The front projection apparatus as claimed in claim 17, wherein the optical engine structure has a center of gravity, while the extending board is in the extended position, a normal of the second supporting surface crossing the center of gravity is adapted to intersect the extending board.

19. The front projection apparatus as claimed in claim 16, wherein the stabilizing device is an auxiliary weight element, disposed on the second supporting surface.
